(19) United States
(12) Patent Application Publication
(10) Pub. No.: US 2018/0298665 A1
(43) Pub. Date: Oct. 18, 2018

(54) HIDDEN CLOSING DOOR SYSTEM

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/569,375

(22) PCT Filed: Aug. 25, 2016
(86) PCT No.: PCT/MX2016/000088

§ 371 Date: Oct. 25, 2017

(30) Foreign Application Priority Data
Oct. 6, 2015 (MX) MX/U/2015/000486

(51) Int. Cl. E05F 3/22; E05F 1/10; E05F 3/12

(52) U.S. Cl. CPC E05F 3/227; E05F 3/12; E05F 1/105

(57) ABSTRACT

A hidden closing door system comprising a rectangular coupling base, a traction axle, a closing control valve, an opening control valve, an adjustment valve, a driving spring, a shock absorber closing piston, a centering nut axle, a gum lock, a metal bush, a traction axle, a traction arm, an opening break, and a fixative screw.

### PREVIEW OF THE INVENTION

The conventional closed door system has one closing speed, with a mechanical-articulated arm. Other systems have an assembly(?) On a vertical position. Another example are the spring closed doors systems. This system does not have a shock absorber break, and an adjustable closing speed, without the same conventional design.

Currently, there are a great number of systems for sliding doors, however, the same designs are poorly aesthetic designed. An example is the closing closet door system with the traditional basic functions. Another example is the sliding door that have tracks, and wheels that run on those tracks. A sliding door system that is hold on top by a lateral mechanism doorlock.

The examples mentioned above have as a limitation the poor aesthetic, that are not reinforced with strong materials, that are noisy, and that they do not have soft closing system.

these limitations have as a consequence, as time passes by, and the daily usage, that the top holder traction system loosens up, and eventually falls down.

This invention seeks to resolve this technical problem by adding a hidden closing system with a double shock absorber traction, and a hidden system to give more aesthetic.

### DESCRIPTION OF THE INVENTION

The novelty of this invention is shown clearly in the drawings that are shown along with this current application, and in according with the description that we describe.

the alpha numeric references belong to each one of the structural elements that integrate this invention.

### BRIEF DESCRIPTION OF THE FIGURES

FIG. 1 is a view of the disassemble of the hidden closing door system and the structural parts that belong in the system.

FIG. 2 is a perspective view of the hidden closing door system.

FIG. 3 is a perspective view of the disassembled traction arm and its structural parts.

FIG. 4 is a perspective view of the traction rail (or traction guide).

FIG. 5 is a perspective view of the traction rail or guide with its plugs.

FIG. 6 is a perspective view of the rectangular accommodation base of the hidden closing door system.

FIG. 7 is a perspective view of the hidden closing door system as a whole unit (complete unit).

### INDETAILED DESCRIPTION OF THE INVENTION

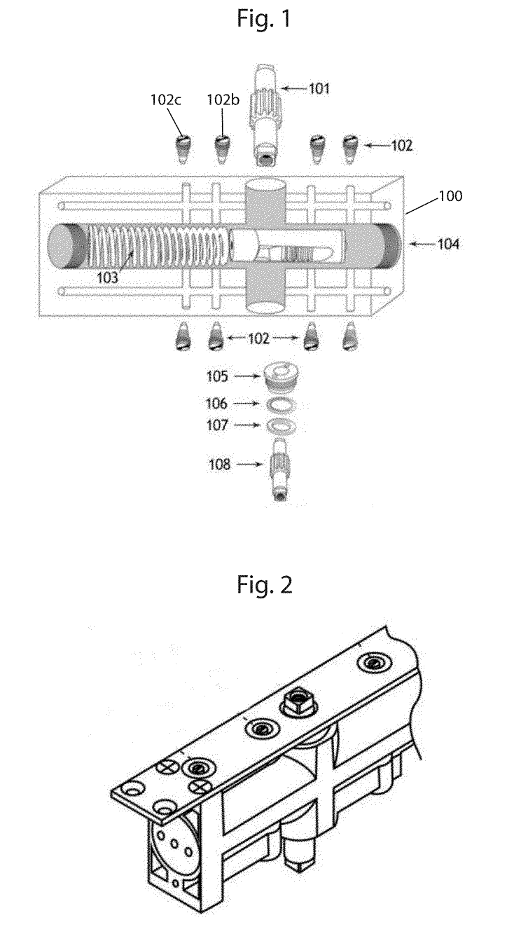

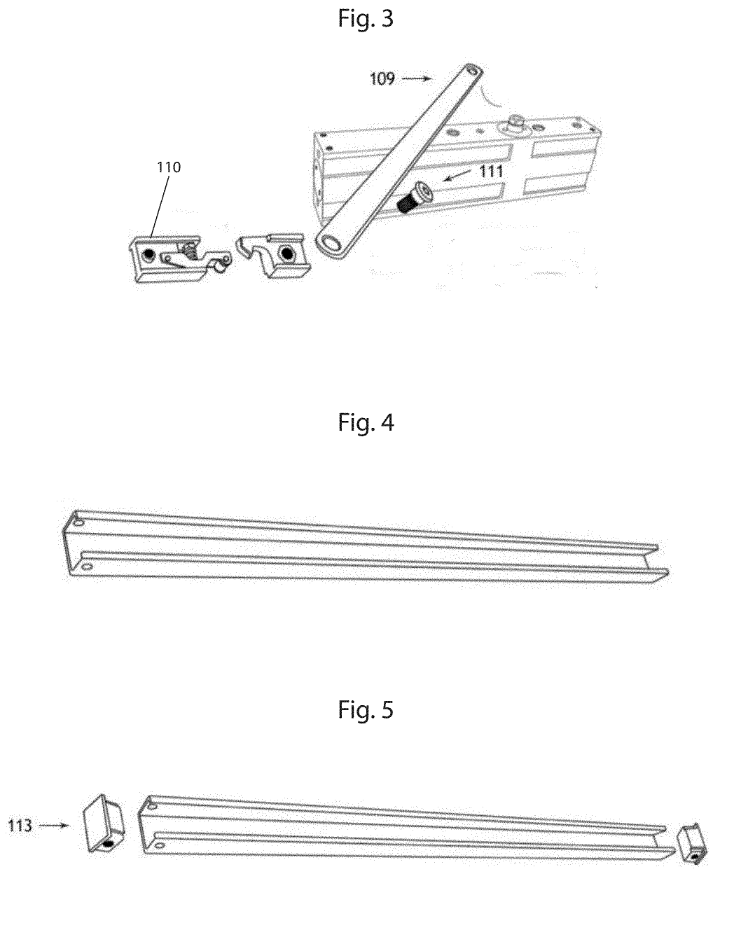

With a reference to FIG. 1, the hidden closing door system has a rectangular base coupling (100), a traction system (101), closing control valve (102), an opening valve (102b), an adjustment valve (102c), a driving spring (103), a closing shock absorber piston (104), a nut that centers the axle (105), a gum lock (106), a metal bush (107), a traction guide (or rail) (108).

With reference to FIG. 2, the hidden closing door system comprehends; a traction arm (109), an opening break system (10), a fixative screw (111).

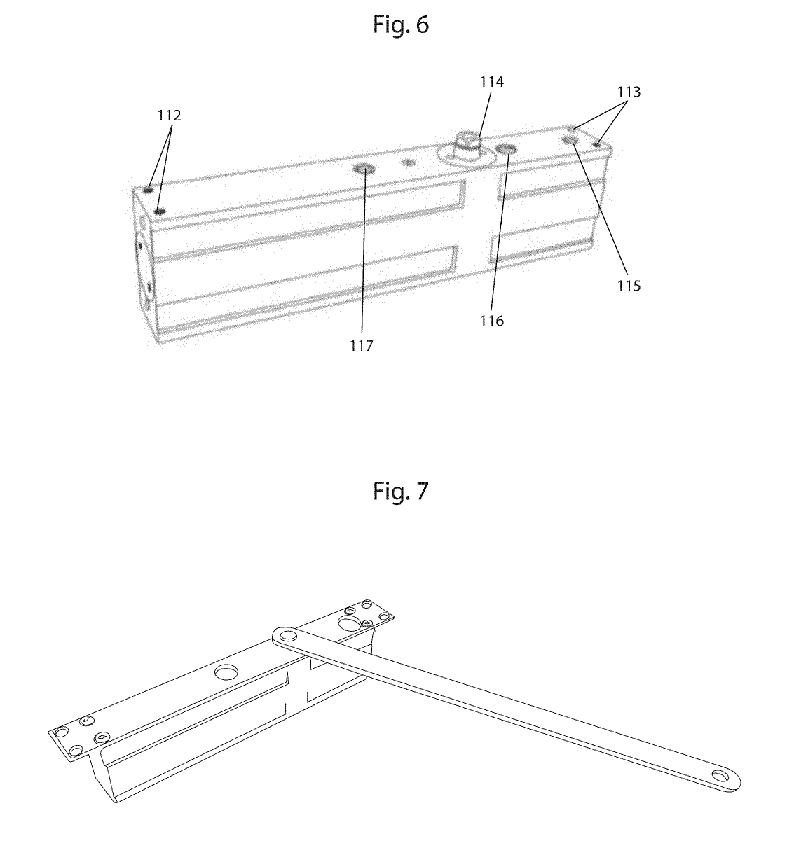

With reference to FIG. 6, the hidden closing door system comprehends a rectangular coupling base (100) with two assembly holes on the right (112), two assembly holes on the left (113), a coupling traction axle hole (114), an closing valve control coupling hole (115), an opening valve control coupling hole (116), a valve adjustment coupling hole (117).

The hidden closing door system is designed to function in doors that have additional strength produced applications due to excessive air flows. When considering this factor in the closing movement of the doors. The driving spring (103) allows the sufficient strength for doors displacement which weight can be up to 65 kgs, which must have a perfect support and movility on their turning point, without showing an excessive resistance to the normal displacement.

the hidden closing door system design allows itself to be hidden between the door and the frame while the door is in closing position, and with the opened door, the only thing one can see is the arm and the traction rail. The exterior design of the closing door system allows that it can be installed on doors with a 4 cm minimum thickness and a 3 cm frame upper part, and it requires that the door must have a solid structure in the upper part with a 10 cm minimum height.

The hidden closing door system is designed to allow the third valve to work as a additional hydraulic system in conjunction with the first valve, giving this way a double shock absorber traction system at the moment when the hidden closing door system starts its work. The third and the first valve regulate the displacement of the closing of the door, that is to say it, from the maximum opening angle (110 degrees) to the minimum opening degree of 15 degrees, theses two valves regulate the timing and speed in the door closing while the door is in the previously mentioned opening range.

within this range, the hidden closing door system has a two shock traction system working together, giving in this form, a bigger resistance.

The function of the second valve mainly consists in to regulate the closing timing, having said that, in the displacement between the 15 degrees to the zero degree, which allows the activation of the doors security system, and in this way, the door gets locked.

1. A hidden closing door system comprising:
a rectangular coupling base;
a track rail or guide system:
a closing control valve;
an opening control valve;
an adjustment valve;
a driving spring;
a closing shock absorber piston;
a central nut that centers the axle;
a gum lock;
a metal bush; and
a traction axle.

2. The hidden closing door system according to claim 1, further comprising:
a coupling rectangular base with two assembly holes on the right;
two assembly holes on the left;
a coupling traction hole;
a closing valve control coupling;
an opening valve control coupling hole; and
an adjustment valve coupling hole.

3. A hidden closing door system comprising:
a traction arm;
an opening break; and
a fixative screw.
